(19) United States
(12) Patent Application Publication
(10) Pub. No.: US 2013/0078831 A1
(43) Pub. Date: Mar. 28, 2013

(54) VERTICAL CONNECTOR AND ASSEMBLY THEREOF

(71) Applicants: CHIN-YU CHIU, NEW TAIPEI CITY (TW); CHENG-CHIH HSU, NEW TAIPEI CITY (TW)

(72) Inventors: CHIN-YU CHIU, NEW TAIPEI CITY (TW); CHENG-CHIH HSU, NEW TAIPEI CITY (TW)

(73) Assignees: KINPO ELECTRONICS, INC., NEW TAIPEI CITY (TW); CAL-COMP ELECTRONICS & COMMUNICATIONS COMPANY LIMITED, NEW TAIPEI CITY (TW)

(21) Appl. No.: 13/605,105

(22) Filed: Sep. 6, 2012

(30) Foreign Application Priority Data
Sep. 26, 2011 (TW) 100217986

(51) Int. Cl. H01R 24/00; H01R 12/51

(52) U.S. Cl. 439/83; 439/660; 439/55

(57) ABSTRACT

The instant disclosure relates to a vertical mount connector, which includes an insulating body, a metal casing, and a terminal assembly. The insulating body has a base and at least one tongue portion extended therefrom. A plurality of terminal grooves is formed and spaced on the insulating body, where each terminal groove concavely extends from the tongue portion to the base. The base defines a plurality of first openings in communication with the terminal grooves. The metal casing is engaged to the insulating body and defines in insertion opening. The terminal assembly includes a plurality of terminals disposed in the terminal grooves. Each terminal has a mounting portion and a connecting portion bendingly extends therefrom. The connecting portions protrude from the base of the insulating body via the first openings.

### BACKGROUND OF THE INVENTION

1. Field of the Invention

The instant disclosure relates to an electrical connector and an assembly thereof; more particularly, to a vertical mount connector and an assembly thereof.

2. Description of Related Art

As electronic devices become more miniaturized, the interior space for housing discrete components is also reduced. In response, the components must adapt structurally to fit in the reduced space. Various miniaturized electrical connectors for data transfer already exist in the market.

Electrical connectors that are vertically mounted on the circuit boards are increasingly more popular. Conventional vertical-mount connectors typically include an insulating body that accommodates a plurality of terminals. The soldering portions of the terminals protrudingly expose from the insulating body. The soldering portions are typically arranged on the underside of the insulating body. When these connectors are mounted to the circuit boards, the connectors are exposed entirely on the circuit boards and create spacing issue.

In addition, to accommodate conventional vertical mount connectors, the interior space of the electronic devices often need to be increased. This increase in spacing acts against the concept of miniaturization. Specifically, existing vertical mount connectors often occupy designated space on the circuit boards reserved for other components. As a result, the overall layout of the circuit boards is adversely affected. To accommodate all necessary components, the size of the circuit boards may have to be increased undesirably. These issues must be resolved to implement the miniaturization of portable electronics while maintaining its performance standards.

To address the above issues, the inventors utilize related industrial experiences and research in providing an improved vertical mount connector and an assembly thereof

### SUMMARY OF THE INVENTION

One of the objects of the instant disclosure is to provide a vertical mount connector with sink board-mounting structure. The size of the connector is reduced in the lengthwise direction versus traditional vertical mount connectors. The reduced size is suitable for use in miniaturized electronic products with reduced profile.

The vertical mount connector of the instant disclosure comprises an insulating body, a metal casing, and a terminal assembly. A plurality of terminal grooves are formed and spaced on the insulating body. The insulating body includes a base and at least one tongue portion formed thereon. Each terminal groove concavely extends from the tongue portion to the base. A plurality of first openings is formed on the base in communication with the terminal grooves. The metal casing receives the insulating body and defines an insertion opening. The terminal assembly includes a plurality of terminals disposed discretely in respective terminal grooves. Each terminal has a mounting portion and a connecting portion bendingly extending therefrom. The connecting portion exposes from the base of the insulating body via the respective first opening.

The instant disclosure also provides a vertical mount connector assembly. The assembly comprises a vertical mount connector and a double-sided circuit board. The vertical mount connector comprises an insulating body, a metal casing, and a terminal assembly. A plurality of terminal grooves are formed and spaced on the insulating body. The insulating body includes a base and at least one tongue portion formed thereon. Each terminal groove extends concavely from the tongue portion to the base. A plurality of first openings is formed on the base in communication with respective terminal grooves. The metal casing receives the insulating body and defines an insertion opening. The terminal assembly includes a plurality of terminals disposed discretely in respective terminal grooves. Each terminal has a mounting portion and a connecting portion bendingly extending therefrom. The connecting portion exposes from the base of the insulating body via the respective first opening. The circuit board defines a mounting slot for receiving the connector, and the connecting portions of the terminals are fixedly mounted on the circuit board.

For the instant disclosure, the connecting portion of each terminal protrudes laterally from the insulating body. The mounting slot of the circuit board serves to receive the connector and secure the connecting portions of the terminals on the circuit board. Thus, the connector coupled to the circuit board takes up less space lengthwise. The connector assembly itself achieves a reduced size to satisfy the miniaturization requirement.

In order to further appreciate the characteristics and technical contents of the instant disclosure, references are hereunder made to the detailed descriptions and appended drawings in connection with the instant disclosure. However, the appended drawings are merely shown for exemplary purposes, rather than being used to restrict the scope of the instant disclosure.

### BRIEF DESCRIPTION OF THE DRAWINGS

FIG. 1 is an exploded view of a vertical mount connector of the instant disclosure.

FIG. 1A is an exploded view of the connector configured for surface-mount technology (SMT) from a different angle.

FIG. 1B is an assembled view of the connector.

FIG. 1C is an assembled view of the connector from a different angle.

FIG. 2 is an exploded view of a connector for an alternative embodiment of the instant disclosure.

FIG. 2A is an exploded view of the connector in FIG. 2 from a different angle.

FIG. 3 is an exploded view of a vertical mount connector configured for dual in-line package (DIP) of the instant disclosure.

FIG. 3A is an assembled view of the connector in FIG. 3.

FIG. 4 is a perspective view showing the assembled SMT connector and circuit board.

### DETAILED DESCRIPTION OF THE EMBODIMENTS

The instant disclosure provides a vertical mount connector and an assembly thereof The connector has a sink board-mounting structure capable of engaging with a circuit board. The connector takes up less space in the lengthwise direction. The assembly is suitable for constructing miniaturized electronic devices.

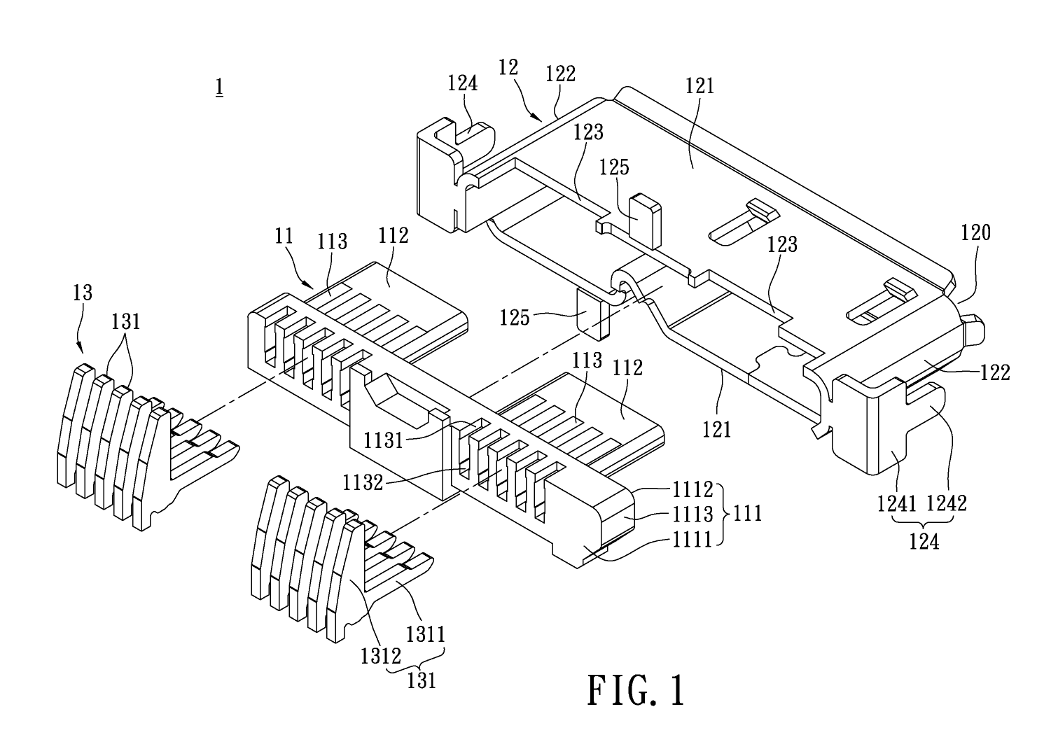

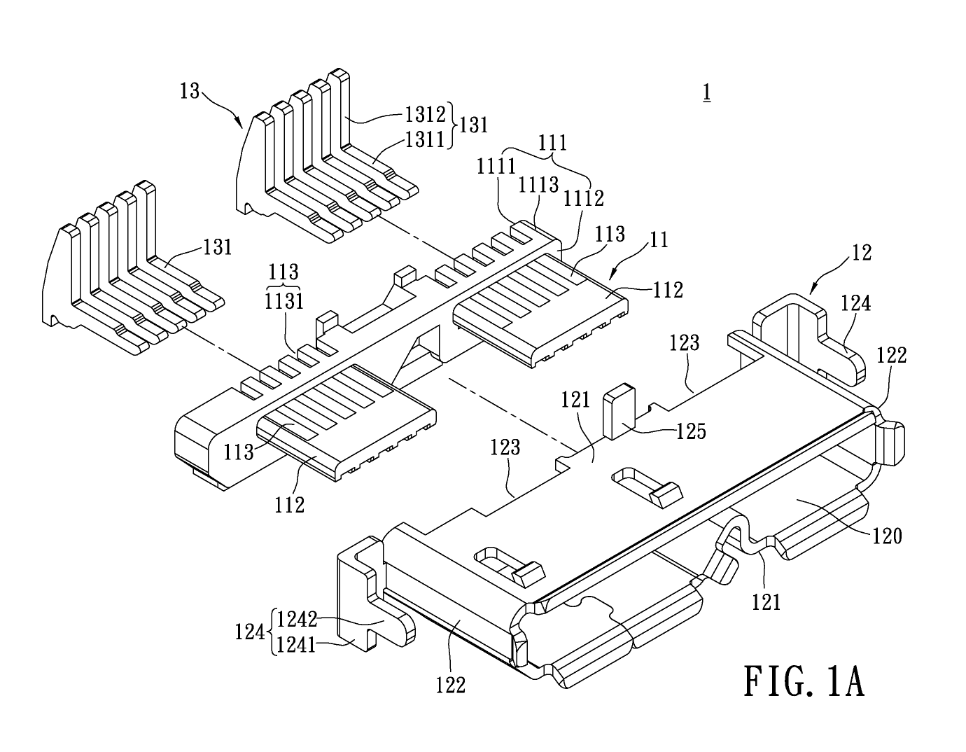

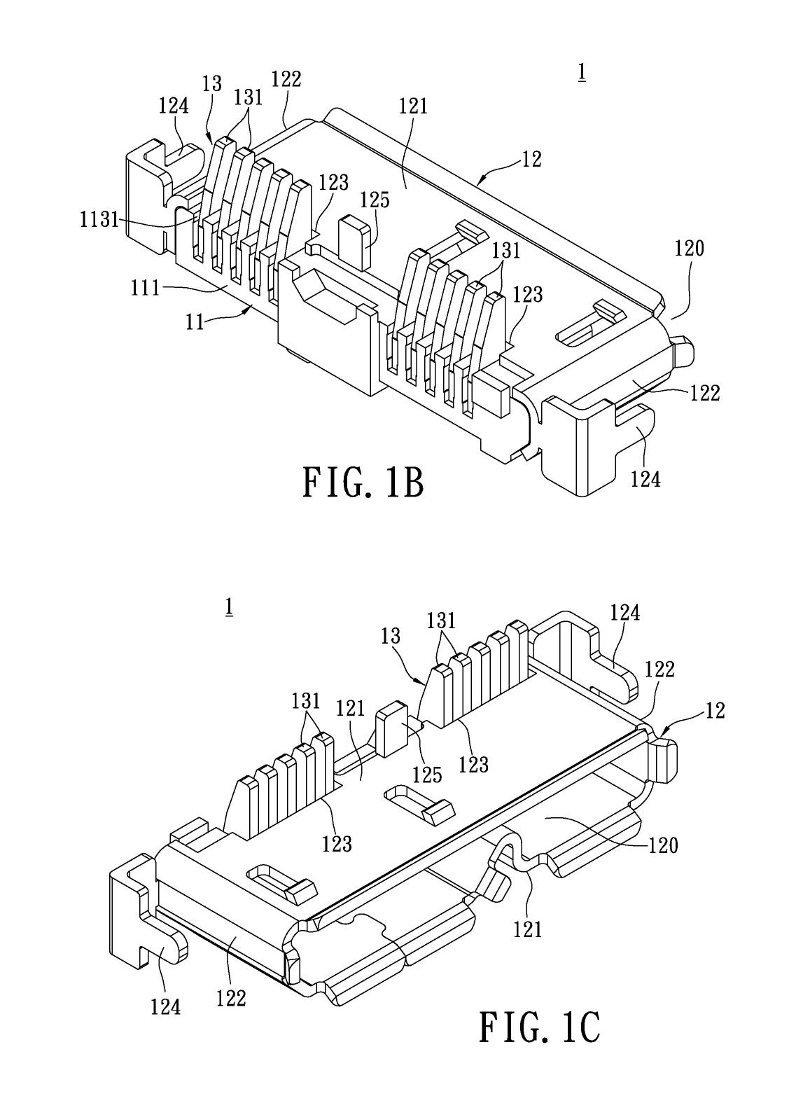

Please refer to FIGS. 1˜1C, which show exploded and perspective views of a vertical mount connector 1 in accordance with the instant disclosure from different angles. The connector 1 is pluggable with a matching connector. For the illustrated embodiment, the connector 1 is a USB standard receptacle engageable by a USB standard plug (not shown). However, the exact configuration of the connector 1 is not restricted thereto. The connector 1 comprises an insulating body 11, a metal casing 12, and a terminal assembly 13. The insulating body 11 makes up the main portion of the connector 1, where the metal casing 12 and the terminal assembly 13 are mounted onto the insulating body 11. A plurality of terminal grooves 113 are formed and spaced on the insulating body 11. The terminal assembly 13 includes a plurality of terminals 131 disposed in the respective terminal grooves 113. The metal casing 12 shapes like a cap that receives the insulating body 11 therein to provide electromagnetic shielding effect. The metal casing 12 further defines an insertion opening 120. The aforementioned plug can be inserted into the metal casing 12 and connect electrically to the terminal assembly 13 through the insertion opening 120.

The insulating body 11 has a base 111 and at least one tongue portion 112 formed thereon. As shown in FIGS. 1 and 1A, for the illustrated embodiment, two tongue portions 112 are formed on the base 111. The terminal grooves 113 extend concavely from the tongue portions 112 to the base 111. The base 111 further defines a plurality of first openings 1131 and second openings 1132 in communication with respective terminal grooves 113. For the illustrated embodiment, the base 111 has a first surface 1111, a second surface 1112 opposite of the first surface 1111, and a side surface 1113 connected therebetween. The first openings 1131 are formed on the side surface 1113, and the second openings 1132 are formed on the first surface 1111.

Please refer to FIGS. 1 and 1B. Each terminal 131 has a mounting portion 1311 and a connecting portion 1312 bendingly extending therefrom. More specifically, each terminal 131 is a metal member having one bend. When assembling the connector 1, the terminals 131 are inserted into respective terminal grooves 113. For example, the mounting portions 1311 of the terminals 131 are fixed inside the terminal grooves 113 by penetrating the second openings 1132. Whereas the connecting portions 1312 are exposed from the base 111 of the insulating body 11 via the first openings 1131. The above configuration allows the circuit board 2 to connect to the side face of the connector 1 instead of its bottom face as traditionally done. This assembling modification markedly reduces the length of protrusion by the connector 1 on the circuit board 2.

To prevent shorting due to inadvertent contact between the terminals 131 and the metal casing 12, the connector 1 further has a guard structure. Please refer back to FIG. 1, wherein the metal casing 12 is substantially a frame-like structure and rectangular in shape. The metal casing 12 has a pair of opposite first walls 121 and a pair of opposite second walls 122. At least one notch 123 is formed on one of the first walls 121 via stamping. As shown in FIGS. 1, 1B, and 1C, two notches 123 are formed on one of the first walls 121 for receiving the connecting portions 1312 of the terminal assembly 13. The notches 123 make the connecting portions 1312 more difficult to make contact with the metal casing 12. In other words, the notches 123 provide a space-buffering effect.

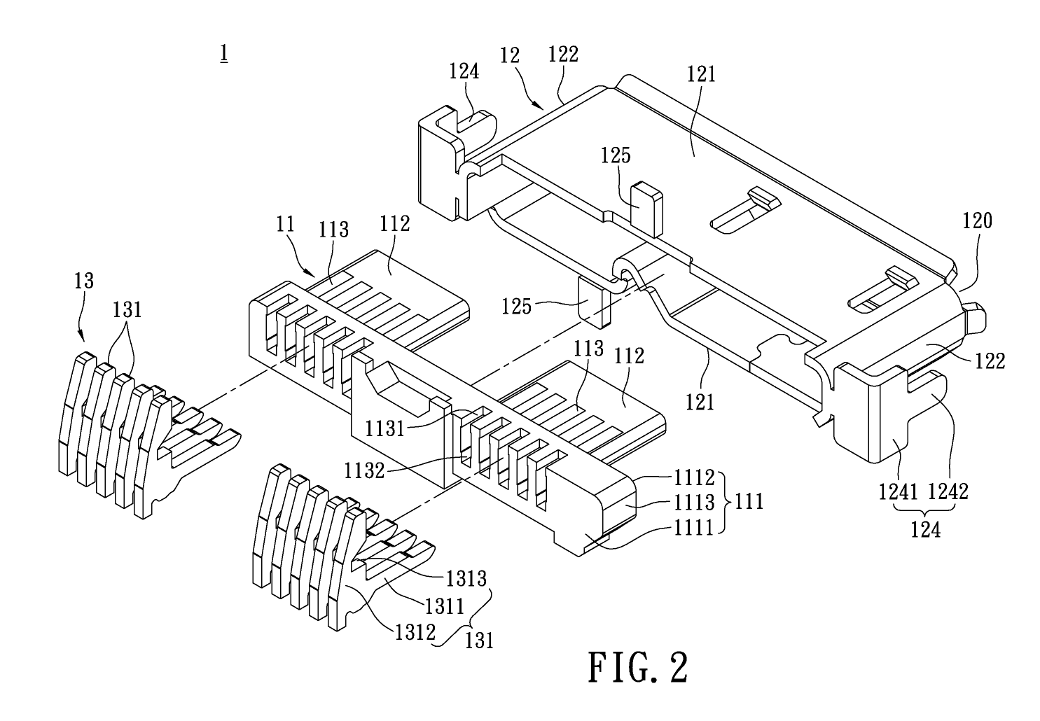

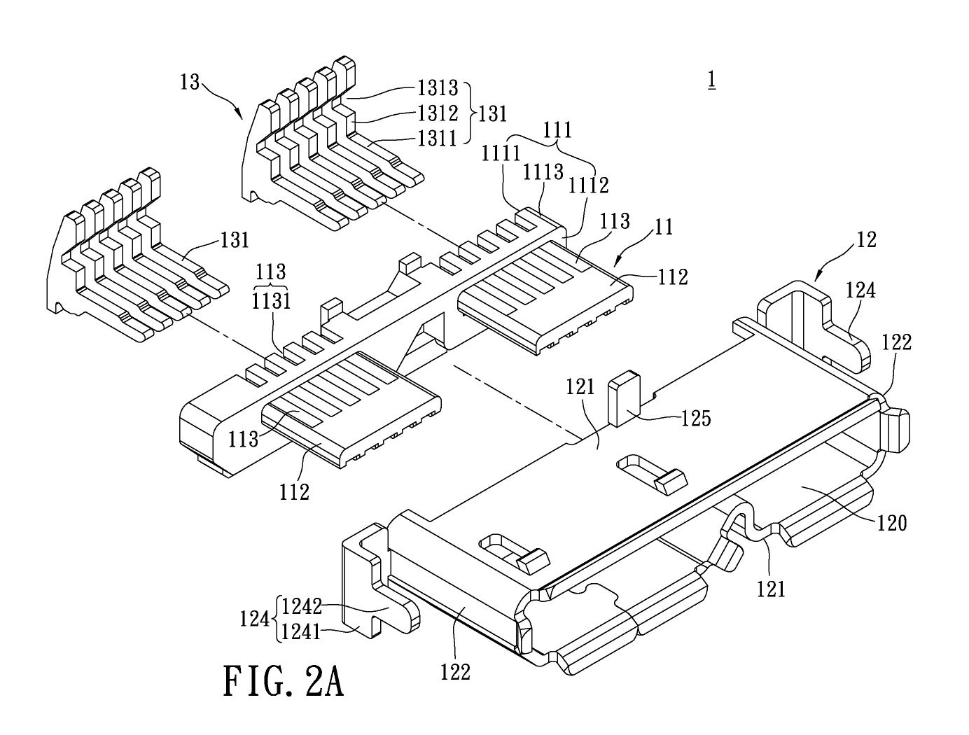

Alternatively, as shown in FIGS. 2 and 2A, the connecting portion 1312 of each terminal 131 may have a cut-out portion 1313. The cut-out portion 1313 creates additional separation distance to further prevent inadvertent contact between the connecting portion 1313 and the metal casing 12. In other words, the metal casing 12 and/or the terminals 131 can be modified structurally to create additional gap therebetween. The utilization of notches 123 and/or cut-out portions 1313 make the metal casing 12 and the terminals 131 less likely to contact each other.

Furthermore, each of the second walls 122 of the metal casing 12 bendably forms a wing member 124. The wing members 124 securely fix the connector 1 to the circuit board 2. Even for repetitive plugging operation, the connector 1 can remain securely engaged to the circuit board 2. In addition, a pair of projections 125 may be formed oppositely on the first walls 121 via stamping. The projections 125 principally function to strengthen the engagement between the connector 1 and the circuit board 2. Specifically, each wing member 124 has an angled portion 1241 bendably extends from the respective second wall 122 and an insertion portion 1242 extending from the angled portion 1241. The insertion portion 1242 is substantially narrower than the angled portion 1241. As will be explained hereinafter in greater detail, this difference in size better secures the connector 1 on the circuit board 2. The projections 125 may be bendingly extending from the first walls 121. However, the number and location of the wing members 124 and projections 125 are not restricted.

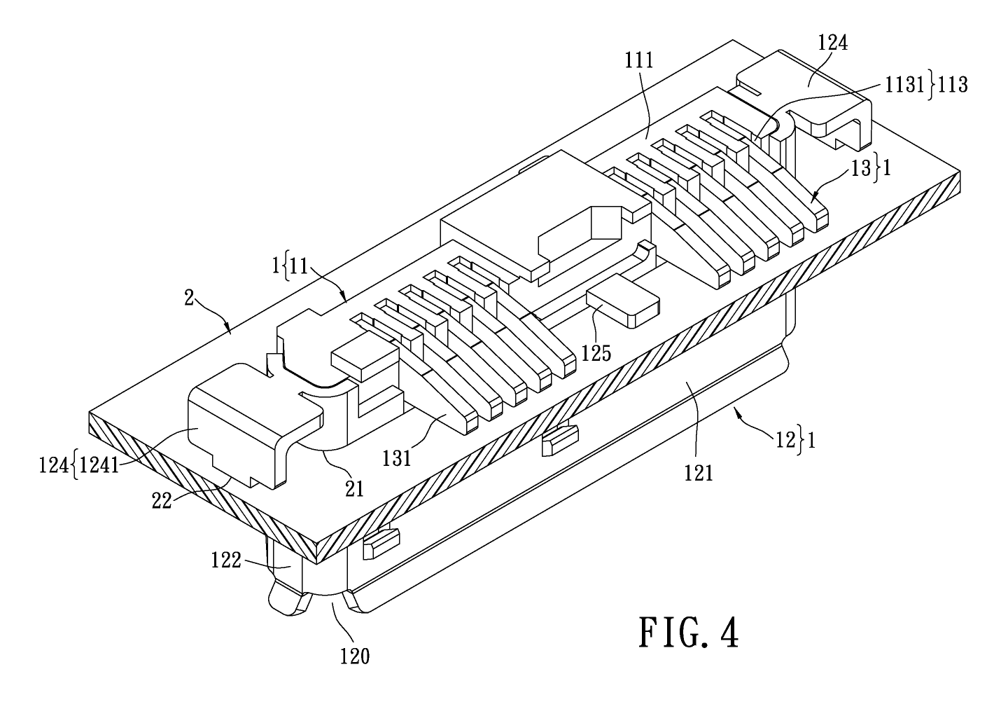

Please refer to FIGS. 1, 1B and 4. FIG. 4 shows an assembled connector 1 and the circuit board 2. Structural characteristics of the connector 1 may be referred from above provided description. It should be noted that the connecting portion 1312 of each terminal 131 is a soldering lead. More specifically, the surface-mount technology (SMT) is utilized to mount the connector 1 onto the circuit board 2. In other words, a plurality of electrical conductive structures (not shown), such as solder pads, is disposed on the circuit board 2 for bonding to the connecting portions 1312.

As best seen in FIG. 4, the circuit board 2 defines a mounting slot 21 for interlocking with the connector 1. When the connector 1 is assembled to the circuit board 2, a portion (e.g., the insertion opening 120 of the metal casing 12) of the connector 1 passes through the mounting slot 21 of the circuit board 2 until the connecting portions 1312 of the terminals 131 contact the circuit board 2. The separation distance between the projections 125 and the insertion opening 120 is substantially the same as that between the connecting portions 1312 and the insertion opening 120. Together the connecting portions 1312 and the projections 125 simultaneously contact the circuit board 2. When the connecting portions 1312 are bonded to the aforementioned conductive structures, the projections 125 provide extra support to enhance overall structural stability. The projections 125 also prevent damages to the terminals 131 due to excessive force during the assembling process.

When the connecting portions 1312 are brought into contact with the circuit board 2, the insertion portions 1242 of the wing members 124 are also inserted through respective fixing slots 22 of the circuit board 2. The engagement between the insertion portions 1242 and the fixing slots 22 provides a securing effect for the assembly. In other words, inadvertent displacement of the connector 1 relative to the circuit board 2 is less likely to occur. As previously mentioned, the size difference between the insertion portions 1242 and the angled portions 1241 provides additional support to enhance structural stability of the assembly.

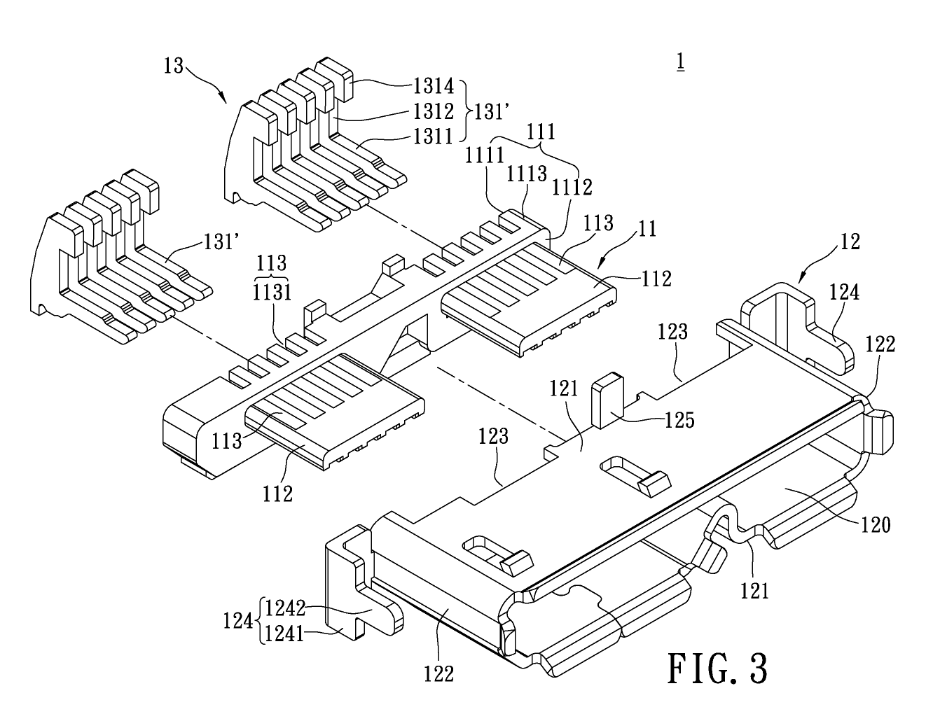

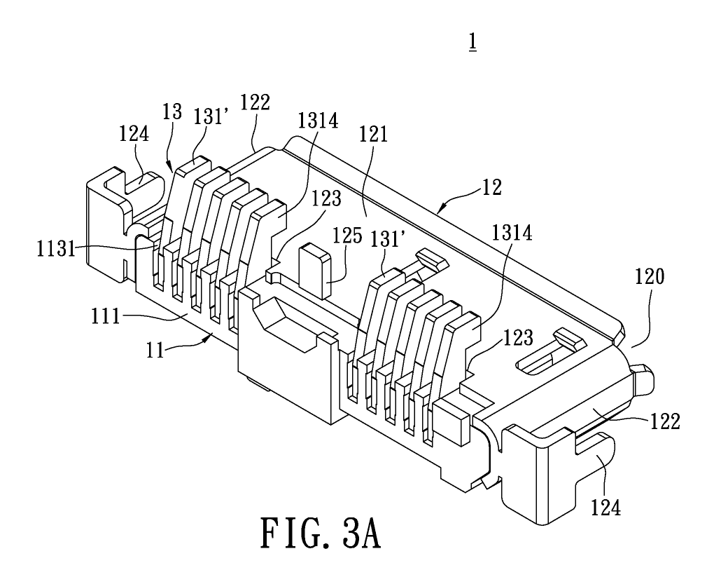

Please refer to FIGS. 3 and 3A, which show the connector 1 for a second embodiment of the instant disclosure. For the instant embodiment, each terminal 131′ is constructed as an insertion lead for a dual in-line package (DIP) connector. In other words, a plugging portion 1314 is extended from the end of each connecting portion 1312 for inserting into respective socket (not shown) formed on the circuit board 2. When the connector 1 is assembled to the circuit board 2, a portion (e.g., the insertion opening 120 of the metal casing 12) of the connector 1 passes through the mounting slot 21 of the circuit board 2 until the plugging portions 1314 of the terminals 131′ engage the sockets and secure to the circuit board 2. As with previous embodiment, the DIP connector 1 may be fitted with supporting and fixing elements. For example, when the plugging portions 1314 are inserted into the sockets of the circuit board 2, the insertion portions 1242 of the wing members 124 of the second wall 122 engage with the fixing slots 22 of the circuit board 2. The engagement between the insertion portions 1242 and the fixing slots 22 provides a securing effect for the assembly as previously described. Likewise, as shown in FIG. 4, the projections 125 also press onto the circuit board 2 in providing additional fixing effect.

For the instant disclosure, each terminal 131 is structurally configured such that the connecting portion 1312 is arranged on the side surface 1113 of the base 111 of the insulating body 11. In other words, the connecting portions 1312 are disposed closer toward the insertion opening 120. When the connector 1 is assembled to the circuit board 2, a portion of the connector 1 is arranged on an opposite side of the double-sided circuit board 2. In other words, the connector 1 straddles across both sides of the circuit board 2 to achieve the sink board-mounting effect and minimize the assembly size.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A vertical mount electrical connector, comprising:
an insulating body including a base and at least one tongue portion extended therefrom having a plurality of spaced terminal grooves defined thereon, each terminal groove concavely extending from the tongue portion to the base, the base defining a plurality of first openings in communication with the terminal grooves;
a metal casing engaged to the insulating body and defining an insertion opening; and
a terminal assembly including a plurality of terminals arranged in the terminal slots, each terminal having a mounting portion and a connecting portion bendingly extending therefrom, each connecting portion being arranged protrudingly on the base of the insulating body via the respective first opening.

2. The vertical mount connector of claim 1, wherein the metal casing has a pair of first walls oppositely arranged and a pair of second walls oppositely arranged, and wherein one of the first walls defines at least one notch to receive the connecting portions.

3. The vertical mount connector of claim 1, wherein the metal casing has a pair of first walls oppositely arranged and a pair of second walls oppositely arranged, and wherein each connecting portion has a cut-out portion.

4. The vertical mount connector of claim 3, wherein the connecting portions are selected from a group consisting of solder leads and insertion leads.

5. The vertical mount connector of claim 2, wherein the connecting portions are selected from a group consisting of soldering leads and insertion leads.

6. The vertical mount connector of claim 3, wherein a wing member is bendingly extending from each second wall.

7. The vertical mount connector of claim 2, wherein a wing member is bendingly extending from each second wall.

8. The vertical mount connector of claim 6, wherein the wing member has an angled portion bendingly extending from the second wall and an insertion portion extended from the angled portion.

9. The vertical mount connector of claim 1, wherein the base has a first surface and a second surface oppositely arranged and a side surface connected therebetween, and wherein the first openings are formed on the side surface.

10. A vertical mount connector assembly, comprising:
a vertical mount connector, comprising:
an insulating body defining a plurality of spaced terminal grooves, the insulating body including a base and at least one tongue portion extended therefrom, each terminal groove being concavely extended from the tongue portion to the base, the base defining a plurality of first openings in communication with the terminal grooves;
a metal casing engaged to the insulating body and defining an insertion opening;
a terminal assembly including a plurality of terminals arranged in the terminal slots, each terminal having a mounting portion and a connecting portion bendingly extending therefrom, each connecting portion being arranged protrudingly on the base of the insulating body via the respective first opening; and
a circuit board defining a mounting slot engaged with the vertical mount connector, the connecting portions being fixedly arranged on the circuit board.

11. The vertical mount connector assembly of claim 10, wherein the metal casing has a pair of first walls oppositely arranged and a pair of second walls oppositely arranged, and wherein one of the first walls defines at least one notch to receive the connecting portions.

12. The vertical mount connector assembly of claim 10, wherein the metal casing has a pair of first walls oppositely arranged and a pair of second walls oppositely arranged, and wherein each connecting portion has a cut-out portion.

13. The vertical mount connector assembly of claim 12, wherein when the connecting portions are solder leads, a plurality of electrically conductive structures are arranged on the circuit board for soldering to the connecting portions, and wherein when the connecting portions are insertion leads, a plurality of sockets are formed on the circuit board for engaging the connecting portions.

14. The vertical mount connector assembly of claim 11, wherein when the connecting portions are solder leads, a plurality of electrically conductive structures are arranged on the circuit board for soldering to the connecting portions, and wherein when the connecting portions are insertion leads, a plurality of sockets are formed on the circuit board for engaging the connecting portions.

15. The vertical mount connector assembly of claim 12, wherein a wing member is bendingly extending from each second wall.

16. The vertical mount connector assembly of claim 11, wherein a wing member is bendingly extending from each second wall.

17. The vertical mount connector assembly of claim 15, wherein the wing member has an angled portion bendingly extending from the second wall and an insertion portion extended from the angled portion, and wherein a plurality of fixing slots is formed on the circuit board engageable with the insertion portions.

18. The vertical mount connector assembly of claim 10, wherein the base has a first surface and a second surface oppositely arranged and a side surface connected therebetween, and wherein the first openings are formed on the side surface.
